(19) United States
(12) Patent Application Publication
(10) Pub. No.: US 2024/0378550 A1
(43) Pub. Date: Nov. 14, 2024

(54) PACKAGE ACCEPTANCE SYSTEM, SERVER, PACKAGE ACCEPTANCE METHOD, AND COMPUTER READABLE MEDIUM

(71) Applicant: NEC Corporation, Minato-ku, Tokyo (JP)

(72) Inventors: Yasushi Nakahata, Tokyo (JP); Daisuke Kawasaki, Tokyo (JP); Kaori Yamane, Tokyo (JP)

(73) Assignee: NEC Corporation, Minato-ku, Tokyo (JP)

(21) Appl. No.: 18/580,673

(22) PCT Filed: Jul. 29, 2021
(86) PCT No.: PCT/JP2021/028189

§ 371 Date: Jan. 19, 2024

(51) Int. Cl. G06Q 10/083; G06Q 20/40; G06Q 30/04; G06V 40/16

(52) U.S. Cl. CPC G06Q 10/0838; G06Q 20/40145; G06Q 30/04; G06V 40/172

(57) ABSTRACT

A system includes: a storage unit that associates face information of a user who requests delivery of a package with user information including information about a sender and a receiver of the package and store the associated information in advance; a camera that captures an image of the face of the user when the package is accepted; a unit that authenticates the captured face of the user; a unit that acquires the user information associated with the authenticated face information of the user from the storage unit; a unit that assigns an invoice number to the delivery of the package; a unit that transmits an instruction for issuance of an invoice including the information about the sender and the receiver included in the acquired user information and the assigned invoice number; and a printer that issues the invoice based on the instruction for issuance.

### TECHNICAL FIELD

The present disclosure relates to a package acceptance system, a server, a package acceptance method, and a computer readable medium.

### BACKGROUND ART

When a user requests the delivery of a package, the acceptance of the package is often carried out at a store such as a business office of a courier or a logistics operator and a convenience store.

At that time, a store clerk at the store measures the dimensions and the weight of the package, and calculates a delivery charge from information such as the dimensions, the weight, and the receiver of the package. Further, the user writes user's information in an invoice by hand and pays the delivery charge at a cash register.

However, there is a problem that measuring the dimensions and the weight of the package and calculating the delivery charge impose a heavy burden on the store clerk. There is also a problem that writing user's information in an invoice by hand and paying the delivery charge at a cash register impose a heavy burden on the user.

Therefore, technologies have recently been proposed to solve the above-described problems.

For example, Patent Literature 1 discloses a technology in which a package pickup apparatus measures the dimensions and the weight of a package, captures an image of the invoice attached to the package, acquires information such as the receiver from the captured image, and calculates a delivery charge from the information about the package such as the dimensions, the weight, and the receiver.

Patent Literature 1 also discloses a technology in which when a person who requests transportation inputs information required for a determination of a delivery charge such as the dimensions, the weight, and the receiver of the package, the package pickup apparatus calculates a delivery charge and performs electronic payment of the delivery charge using payment information (the credit card number etc.) of the person who requests transportation registered in a server in advance.

Patent Literature 1 also discloses a technology in which identification information of a person who requests transportation is associated with a face image of the person who requests transportation, and the package pickup apparatus identifies the person who requests transportation by using face authentication and acquires information such as the receiver of the package from the server.

### CITATION LIST

### Patent Literature

Patent Literature 1: Japanese Unexamined Patent Application Publication No. 2020-057056

### SUMMARY OF INVENTION

### Technical Problem

As described above, according to the technologies disclosed in Patent Literature 1, since the package pickup apparatus measures the dimensions and the weight of a package, calculates a delivery charge, and performs payment, some of the burdens on a store clerk and a user (a person who requests transportation) are reduced.

However, according to the technologies disclosed in Patent Literature 1, since a user (a person who requests transportation) needs to prepare an invoice in advance, the burden of preparing the invoice on the user cannot be reduced.

Therefore, an object of the present disclosure is to provide a package acceptance system, a server, a package acceptance method, and a computer readable medium that are capable of solving the above-described problem, and reducing the burden of preparing an invoice on a user.

### Solution to Problem

A package acceptance system according to an example aspect includes:
a storage unit configured to associate face information of a user who requests delivery of a package with user information including information about a sender and a receiver of the package and store the associated information in advance;
a camera configured to capture an image of the face of the user when the package is accepted;
a face authentication unit configured to authenticate the captured face of the user;
a user information acquisition unit configured to acquire the user information associated with the authenticated face information of the user from the storage unit;
an invoice number assignment unit configured to assign an invoice number to the delivery of the package;
an issuance instruction unit configured to transmit an instruction for issuance of an invoice including the information about the sender and the receiver included in the acquired user information and the assigned invoice number; and
a printer configured to issue the invoice based on the instruction for issuance.

A server according to an example aspect includes:
a storage unit configured to associate face information of a user who requests delivery of a package with user information including information about a sender and a receiver of the package and store the associated information in advance;
a face authentication unit configured to authenticate the face of the user captured by a camera when the package is accepted;
a user information acquisition unit configured to acquire the user information associated with the authenticated face information of the user from the storage unit;
an invoice number assignment unit configured to assign an invoice number to the delivery of the package; and
an issuance instruction unit configured to transmit, to a printer, an instruction for issuance of an invoice including the information about the sender and the receiver included in the acquired user information and the assigned invoice number.

A package acceptance method according to an example aspect is a package acceptance method performed by a server, the package acceptance method including:
associating face information of a user who requests delivery of a package with user information including information about a sender and a receiver of the package and storing the associated information in a storage unit in advance;
authenticating the face of the user captured by a camera when the package is accepted;
acquiring the user information associated with the authenticated face information of the user from the storage unit;
assigning an invoice number to the delivery of the package; and
transmitting, to a printer, an instruction for issuance of an invoice including the information about the sender and the receiver included in the acquired user information and the assigned invoice number.

A computer readable medium according to an example aspect is a non-transitory computer readable medium storing a program for causing a computer to execute:
a procedure of associating face information of a user who requests delivery of a package with user information including information about a sender and a receiver of the package and storing the associated information in a storage unit in advance;
a procedure of authenticating the face of the user captured by a camera when the package is accepted;
a procedure of acquiring the user information associated with the authenticated face information of the user from the storage unit;
a procedure of assigning an invoice number to the delivery of the package; and
a procedure of transmitting, to a printer, an instruction for issuance of an invoice including the information about the sender and the receiver included in the acquired user information and the assigned invoice number.

### Advantageous Effects of Invention

According to the above-described example aspects, it is possible to achieve an effect that a package acceptance system, a server, a package acceptance method, and a computer readable medium that are capable of reducing the burden of preparing an invoice on a user can be provided.

### BRIEF DESCRIPTION OF DRAWINGS

FIG. 1 is a diagram showing an example of a configuration of a package acceptance system according to a first example embodiment;

FIG. 2 is a diagram showing an example in which an information terminal, a measuring unit, a weight scale, and a printer shown in FIG. 1 are installed in a store;

FIG. 3 is a sequence diagram for explaining an example of operations performed by the package acceptance system according to the first example embodiment;

FIG. 4 is a diagram showing an example of an operation screen to be displayed on a display unit in Step S103 shown in FIG. 3;

FIG. 5 is a diagram showing an example of an operation screen to be displayed on the display unit in Step S108 shown in FIG. 3;

FIG. 6 is a diagram showing an example of an operation screen to be displayed on the display unit in Step S109 shown in FIG. 3;

FIG. 7 is a diagram showing an example of an operation screen to be displayed on the display unit in Step S113 shown in FIG. 3;

FIG. 8 is a diagram showing an example of an invoice issued by a printer in Step S116 shown in FIG. 3;

FIG. 9 is a diagram showing an example of a configuration of a package acceptance system according to a second example embodiment;

FIG. 10 is a diagram showing an example of a configuration of a package acceptance system according to a third example embodiment; and

FIG. 11 is a block diagram showing an example of a hardware configuration of a server according to a fourth example embodiment.

### EXAMPLE EMBODIMENT

Example embodiments of the present disclosure will be described hereinafter with reference to the drawings. Note that, for the clarification of the description, the following descriptions and the drawings are partially omitted and simplified as appropriate. Further, the same elements are denoted by the same reference symbols throughout the drawings, and redundant descriptions are omitted as necessary.

### First Example Embodiment

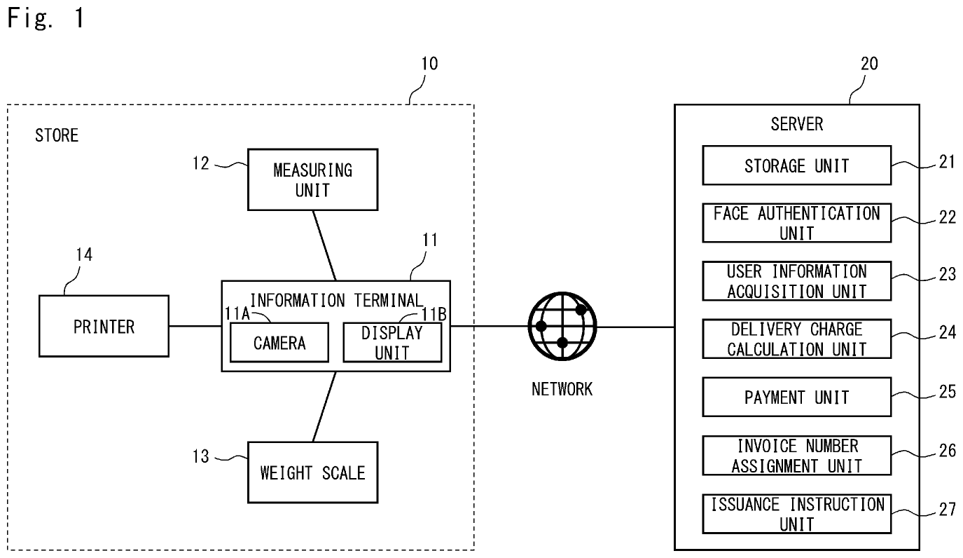

First, an example of a configuration of a package acceptance system according to a first example embodiment will be described with reference to FIG. 1.

As shown in FIG. 1, the package acceptance system according to the first example embodiment includes an information terminal 11, a measuring unit 12, a weight scale 13, a printer 14, and a server 20. Of these components, the information terminal 11, the measuring unit 12, the weight scale 13, and the printer 14 are installed in a store 10 (e.g., a business office of a courier or a logistics operator, a convenience store) that accepts a package P to be delivered from a user. Meanwhile, the server 20 is connected to the information terminal 11 through a network and installed in any place. Note that the network that connects the information terminal 11 to the server 20 may be either a wired network or a wireless network.

First, a configuration on the store 10 side will be described.

The information terminal 11 includes a camera 11A and a display unit 11B of a touch panel type. For example, the information terminal 11 is implemented by a tablet terminal.

The camera 11A captures the face of a user and acquires a face image of the user.

The display unit 11B displays various operation screens.

The information terminal 11 displays an operation screen on the display unit 11B and receives an operation performed by a user touching the operation screen. The information terminal 11 is an example of an operation reception unit.

Further, the information terminal 11 has a function of performing communication with the server 20 through a network. For example, the information terminal 11 transmits to the server 20 information such as the content of the operation performed by the user, the face image of the user acquired by the camera 11A, and information about the dimensions and the weight of the package P measured by the measuring unit 12 and the weight scale 13 described later. Further, the information terminal 11 receives from the server 20 an instruction for issuance of an invoice (a slip) to the printer 14 described later, and the like.

The measuring unit 12 measures the dimensions (width, length, height) of the package P. The measuring unit 12 is an example of a dimension measurement unit. The measuring unit 12 includes a depth sensor 12A described later. The depth sensor 12A is disposed at a position where an image of the package P can be captured from directly above it, and captures an image of the package P to acquire a depth image indicating the depth (the distance) from the depth sensor 12A to the package P. Then the measuring unit 12 calculates the dimensions of the package P based on the depth image acquired by the depth sensor 12A. Note that, as a calculation method for calculating the dimensions of the package P based on the depth image, any method already known can be used. Therefore, the detailed description of the method for calculating the dimensions of the package P will be omitted here.

The weight scale 13 measures the weight of the package P. The weight scale 13 is an example of a weight measurement unit. The weight scale 13 includes a weight scale body part 13A and a weight display unit 13B, which will be described later. The package P is placed on the weight scale body part 13A, and the weight scale body part 13A measures the weight of the package P. The weight display unit 13B displays the weight of the package P measured by the weight scale body part 13A. Note that the weight display unit 13B may have a function of receiving operations such as turning on/off a power supply.

The printer 14 issues an invoice to be attached to the package P based on an insurance instruction received from the server 20. In the invoice of the package P, information (name, address, telephone number, etc.) about a sender (a user in many cases), information (name, address, telephone number, etc.) about a receiver, the invoice number, and the like are described. Note that the printer 14 may issue an invoice using a two-dimensional code such as a Quick Response (QR) code (Registered Trademark). By doing so, the information about the sender and the receiver included in the invoice cannot be visually recognized, and thus personal information can be protected.

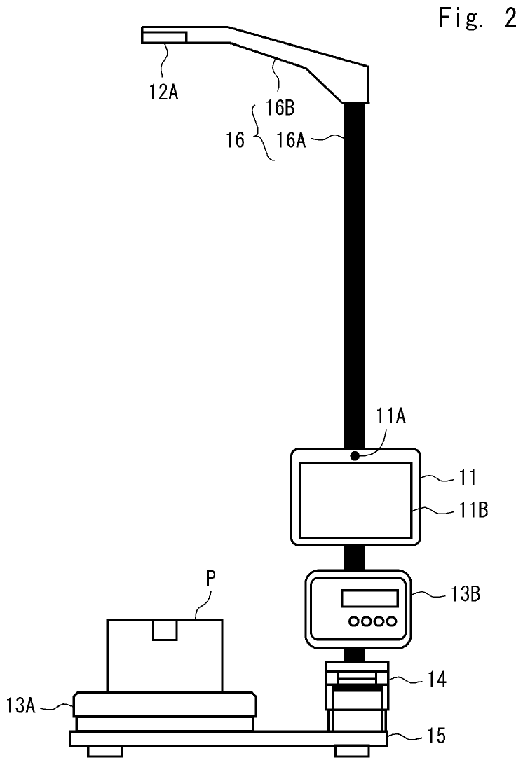

An example in which the information terminal 11, the measuring unit 12, the weight scale 13, and the printer 14 are installed in the store 10 will be described below with reference to FIG. 2.

In the installation example shown in FIG. 2, the weight scale body part 13A and the printer 14 are placed on a mounting table 15. The package P is placed on the weight scale body part 13A.

The depth sensor 12A is attached to the mounting table 15 via a sensor attachment part 16 so that the package P placed on the weight scale body part 13A is disposed at a position where an image of the package P can be captured from directly above it. The sensor attachment part 16 includes a support pillar 16A vertically installed on the mounting table 15 and a sensor attachment member 16B installed on an upper end of the support pillar 16A.

The information terminal 11 is attached to the support pillar 16A and is detachable therefrom. Therefore, although the camera 11A mounted on the information terminal 11 is normally used to capture an image of the face of a user, it may be detached from the support pillar 16A and used, for example, to capture an image of the package P. Note that, in FIG. 2, although the position where the camera 11A is disposed in the information terminal 11 is an upper center of the information terminal 11, it is not limited thereto.

The weight display unit 13B is also attached to the support pillar 16A. Note that the weight display unit 13B, like the information terminal 11, may be attached to the support pillar 16A and is detachable therefrom.

In the installation example shown in FIG. 2, when a user places the package P on the weight scale body part 13A, the camera 11A can acquire a face image of the user. At this time, the information terminal 11 may display an operation screen urging the user to turn the user's face toward the camera 11A on the display unit 11B, or may output a voice urging the user to turn the user's face toward the camera 11A from a speaker (not shown).

Further, when the package P is placed on the weight scale body part 13A, the weight scale body part 13A can measure the weight of the package P. Further, since the depth sensor 12A can capture an image of the package P from directly above it and acquire a depth image, the measuring unit 12 can measure the dimensions of the package P. Therefore, in the installation example shown in FIG. 2, the weight and the dimensions of the package P placed on the weight scale body part 13A can be measured simultaneously.

Next, a configuration of the server 20 will be described.

As shown in FIG. 1, the server 20 includes a storage unit 21, a face authentication unit 22, a user information acquisition unit 23, a delivery charge calculation unit 24, a payment unit 25, an invoice number assignment unit 26, and an issuance instruction unit 27.

The storage unit 21 associates face information indicating a face image of a user with user information of the user in advance and stores them. The user information includes information (name, address, telephone number, etc.) about a sender (a user in many cases) of the package P, information (name, address, telephone number, etc.) about a receiver of the package P, and payment information related to payment made by a user (credit card number etc.). Note that the user information may include information about a plurality of receivers (i.e., destinations) such as home, user's parents' home, and business contacts. When the user information includes the information about a plurality of receivers, the information terminal 11 causes the user to select one of the plurality of receivers as described later.

Note that a user may register face information of the user and user information to be stored in the storage unit 21 by using the information terminal 11 or by using a terminal (not shown) owned by the user (e.g., a smartphone, a tablet terminal, a mobile phone, and a personal computer).

When the package P is received from a user, a face image of the user is first transmitted to the server 20 from the information terminal 11.

When the face image of the user is received from the information terminal 11, the face authentication unit 22 authenticates the face of the user. Specifically, the face authentication unit 22 determines whether or not the face in the face image received from the information terminal 11 is one of the faces in the face information stored in the storage unit 21.

When the face of the user is authenticated by the face authentication unit 22 (i.e., when face authentication is successfully performed), the user information acquisition unit 23 acquires, from the storage unit 21, user information which is associated with the face information of the user and is stored in the storage unit 21.

Further, when the face of the user is authenticated by the face authentication unit 22, the information terminal 11 subsequently transmits to the server 20 package information including the dimensions and the weight of the package P, whether or not a delivery option is added to the package P, and the type of the delivery option when the delivery option is added. The type of the delivery option is, for example, a specific delivery form (refrigerated delivery, air delivery, etc.), date designation, and a limited express delivery. A user selects, through the information terminal 11, whether or not to add a delivery option and the type of the delivery option when the delivery option is added. Further, the dimensions and the weight of the package P are measured by the measuring unit 12 and the weight scale 13, respectively.

When the package information is received from the information terminal 11, the delivery charge calculation unit 24 calculates a delivery charge for the package P. Specifically, the delivery charge calculation unit 24 calculates a delivery charge based on the current location (the location of the store 10), the information about the receivers included in the user information acquired from the storage unit 21 by the user information acquisition unit 23, the dimensions and the weight of the package P included in the package information received from the information terminal 11, whether or not a delivery option is added to the package P, and the type of the delivery option when the delivery option is added. Note that when the user information includes information about a plurality of receivers, the delivery charge calculation unit 24 calculates a delivery charge based on information about a receiver selected by a user from among the plurality of receivers through the information terminal 11.

When a delivery charge for the package P is calculated by the delivery charge calculation unit 24, the payment unit 25 performs payment of the delivery charge based on the payment information included in the user information acquired from the storage unit 21 by the user information acquisition unit 23.

The invoice number assignment unit 26 assigns an invoice number to the delivery of the package P.

The issuance instruction unit 27 transmits to the information terminal 11 an instruction for issuance of an invoice including information about the sender and the receiver included in the user information acquired from the storage unit 21 by the user information acquisition unit 23 and the invoice number assigned by the invoice number assignment unit 26. Note that when the user information includes information about a plurality of receivers, the issuance instruction unit 27 includes, in the instruction for issuance, information about a receiver selected by a user from among the plurality of receivers through the information terminal 11.

Note that, although it is assumed that the timing at which the invoice number is assigned and the instruction for issuance is transmitted is a timing after the payment unit 25 performs the payment of the delivery charge, the present disclosure is not limited thereto. In the present disclosure, since a user is permitted to pay the delivery charge at a cash register (not shown) of the store 10, the payment unit 25 may not perform the payment. Therefore, the timing at which the invoice number is assigned and the instruction for issuance is transmitted may be a timing after the user information is acquired from the storage unit 21 by the user information acquisition unit 23 or a timing after the delivery charge is calculated by the delivery charge calculation unit 24. Note that when the delivery charge is paid at the cash register of the store 10, the delivery charge calculation unit 24 transmits information about the delivery charge to the information terminal 11.

The storage unit 21 associates package information of the package P with face information of a user and user information and stores them.

Note that, in the installation example shown in FIG. 2, the information terminal 11 is attached to the support pillar 16A and is detachable therefrom. Therefore, the camera 11A mounted on the information terminal 11 can be detached from the support pillar 16A to capture an image of the package P. Therefore, the camera 11A may capture an image of the package P when the package P is accepted at the store 10, and the storage unit 21 may associate the image of the package P captured when the package P is accepted at the store 10 with the package information of the package P, the face information of the user, and the user information and store them. In this case, the package P delivered to the receiver can be compared with the image of the package P captured when the package P is accepted at the store 10. Therefore, it can be determined whether or not the package P is damaged.

Further, after the package P is picked up at the store 10, it is usually delivered to the receiver via one or more delivery bases. Therefore, an image of the package P is captured by a camera at each delivery base through which the package P passes, and the storage unit 21 may associate the image of the package P captured when the package P is accepted at the store 10 and the image of the package P captured at each delivery base with the package information of the package P, the face information of the user, and the user information, and store them. In this case, the package P delivered to the receiver can be compared with the image of the package P captured when the package P is accepted at the store or the image of the package P captured at each delivery base. Therefore, it is 10 not only possible to determine whether or not the package P is damaged, but also, if it is damaged, to determine by which process it was damaged.

Next, an example of operations performed by the package acceptance system according to the first example embodiment will be described with reference to FIG. 3. Note that, in FIG. 3, a description will be given in accordance with the assumption that the information terminal 11, the measuring unit 12, the weight scale 13, and the printer 14 are installed in the store 10 as shown in the installation example of FIG. 2. Further, in FIG. 3, for the sake of simplicity of explanation, only a specific delivery form (refrigerated delivery, air delivery, etc.) can be selected as a type of the delivery option.

As shown in FIG. 3, a user performs member registration in advance and registers face information of the user and user information (information about a sender and a receiver, payment information). This registration may be performed using the information terminal 11 or a terminal (not shown) owned by the user. The storage unit 21 associates the face information and the user information registered by the user with each other and stores them (Step S101).

When a user requests the delivery of the package P at the store 10, the user places the package P on the weight scale body part 13A composing the weight scale 13 (Step S102).

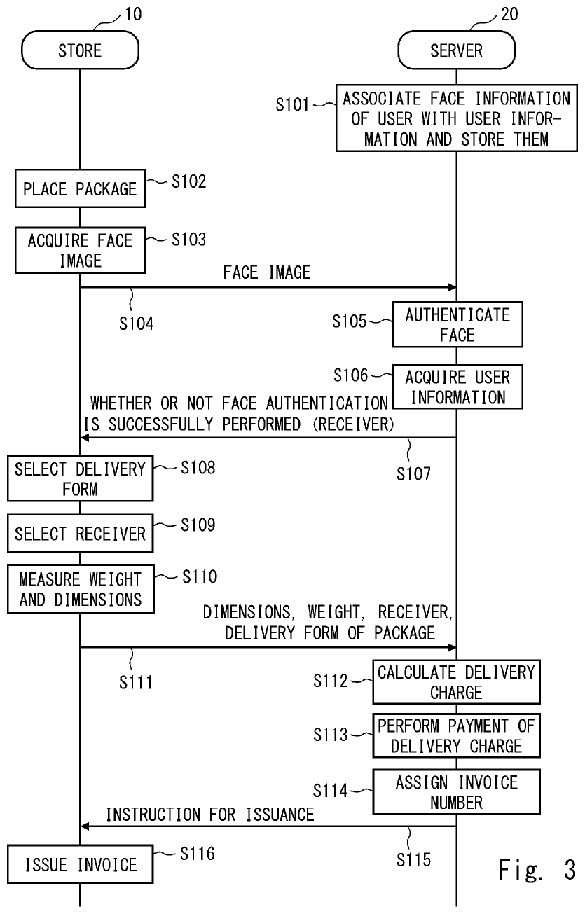

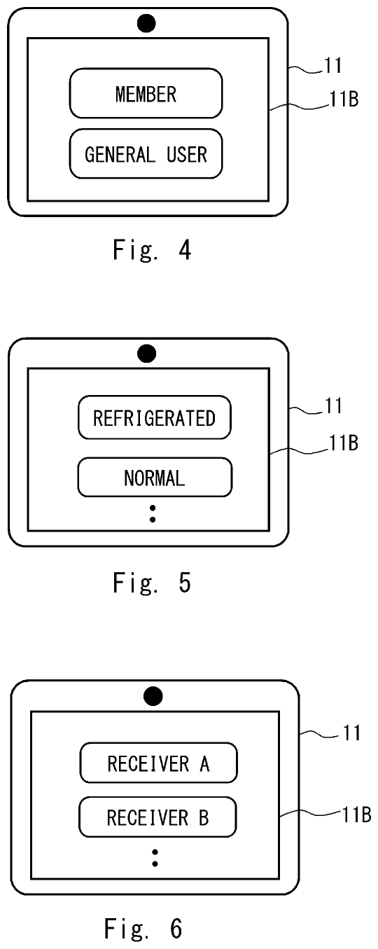

Next, the information terminal 11 acquires a face image of the user by using the camera 11A (Step S103), and transmits the acquired face image of the user to the server 20 (Step S104). At this time, the information terminal 11 may display the operation screen as shown in FIG. 4 on the display unit 11B, and execute Steps S103 and S104 only when a user selects that the user is a registered member. Note that, when a user selects that the user is a general user, the information terminal 11 may display an operation screen urging the user to register as a member on the display unit 11B. Further, when a user selects not to perform membership registration, the information terminal 11 may proceed with processing in which the user pays the delivery charge at a cash register of the store 10. On the other hand, when a user selects to perform membership registration, the information terminal 11 may display an operation screen urging a user to register face information of the user and user information on the display unit 11B. For example, the information terminal 11 may acquire face information of a user by using the camera 11A, and may receive an input of user information on the operation screen described above. When the face information of the user and the user information are registered, the information terminal 11 associates the face information of the user and the user information with each other and stores them in the storage unit 21.

Next, the face authentication unit 22 authenticates the face of the user based on the face image of the user received in Step S104 (Step S105). Specifically, the face authentication unit 22 determines whether or not the face in the face image received from the information terminal 11 is one of the faces in the face information stored in the storage unit 21.

When the face of the user is authenticated in Step S105 (i.e., when face authentication is successfully performed), the user information acquisition unit 23 acquires, from the storage unit 21, user information which is associated with the face information of the user and is stored in the storage unit 21 (Step S106).

Next, the user information acquisition unit 23 transmits information indicating whether or not the face authentication is successfully performed in Step S105 to the information terminal 11. Further, when the face of the user is authenticated in Step S105 and the user information acquired in Step S106 includes information about a plurality of receivers, the user information acquisition unit 23 transmits the information about a plurality of receivers to the information terminal 11 in order to make a user select a receiver (Step S107). A description will be given below in accordance with the assumption that the face of a user has been authenticated and information about a plurality of receivers has been transmitted to the information terminal 11.

When information indicating that the face authentication is successfully performed is received in Step S107, the information terminal 11 displays an operation screen as shown in FIG. 5 on the display unit 11B, and makes a user select a delivery form of the package P (Step S108).

Next, the information terminal 11 displays an operation screen showing a list of a plurality of receivers as shown in FIG. 6 on the display unit 11B, and makes a user select one of the plurality of receivers (Step S109).

Meanwhile, the weight scale 13 measures the weight of the package P placed on the weight scale body part 13A, and the measuring unit 12 measures the dimensions (width, length, height) of the package P using the depth sensor 12A (Step S110).

Note that the timing at which the dimensions and the weight of the package P are measured is not limited to the above timing. The timing at which the dimensions and the weight of the package P may be, for example, a timing at which the package P is placed on the weight scale body part 13A in Step S102, or a timing at which the information indicating that the face authentication is successfully performed is received in Step S107.

Next, the information terminal 11 transmits package information including the dimensions and the weight of the package P measured in Step S110 and the delivery form of the package P selected in Step S108 to the server 20 and transmits information about the receiver selected in Step S109 to the server 20 (Step S111).

Next, the delivery charge calculation unit 24 calculates a delivery charge for the package P based on the current location (the location of the store 10), the information about the receiver of the package P, and the dimensions, the weight, and the delivery form of the package P included in the package information received in Step S111 (Step S112). At this time, when the user information acquired in Step S106 includes information about a plurality of receivers, the delivery charge calculation unit 24 calculates a delivery charge using information about the receiver received together with the package information in Step S111. On the other hand, when the user information acquired in Step S106 includes information about only one receiver, the delivery charge calculation unit 24 calculates a delivery charge using the one receiver.

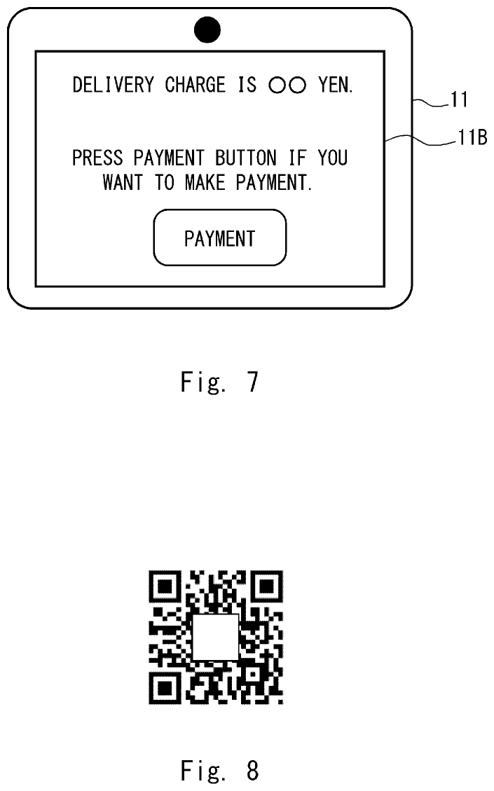

Next, the payment unit 25 performs payment of the delivery charge for the package P calculated in Step S112 based on payment information included in the user information acquired in Step S106 (Step S113). At this time, the payment unit 25 may obtain the consent of a user before the payment of the delivery charge, and then perform the payment of the delivery charge. In this case, for example, the payment unit 25 may transmit information about the delivery charge for the package P to the information terminal 11, and the information terminal 11 may display an operation screen showing the delivery charge for the package P and a payment button as shown in FIG. 7 on the display unit 11B, and obtain the consent of a user to perform the payment of the delivery charge.

Next, the invoice number assignment unit 26 assigns an invoice number to the delivery of the package P (Step S114).

Next, the issuance instruction unit 27 transmits an instruction for issuance of an invoice including the information about the sender of the package P included in the user information acquired in Step S106, the information about the receiver of the package P, and the invoice number assigned in Step S114 to the information terminal 11 (Step S115). At this time, when the user information acquired in Step S106 includes information about a plurality of receivers, the issuance instruction unit 27 includes the information about the receiver received together with the package information in Step S111 in the instruction for issuance. On the other hand, when the user information acquired in Step S106 includes information about only one receiver, the issuance instruction unit 27 includes the information about the one receiver in the instruction for issuance.

Then, the instruction for issuance received by the information terminal 11 in Step S115 is transferred from the information terminal 11 to the printer 14, and the printer 14 issues an invoice to be attached to the package P based on the transferred instruction for issuance (Step S116). In the invoice of the package P, information (name, address, telephone number, etc.) about a sender (a user in many cases), information (name, address, telephone number, etc.) about a receiver, the invoice number, and the like are described. Note that the printer 14 may issue an invoice using a two-dimensional code such as a QR code. FIG. 8 shows an example of an issued invoice using a QR code. By doing so, the information about the sender and the receiver included in the invoice cannot be visually recognized, and thus personal information can be protected. Note that, in FIG. 8, although information described in the center of the QR code is not disclosed, this information described in the center of the QR code is disclosed in an actual invoice.

In FIG. 3, when the user information acquired in Step S106 includes information about only one receiver, the information about the receiver is not transmitted from the server 20 to the information terminal 11. However, the present disclosure is not limited thereto. Even when the user information includes information about only one receiver, the information about the receiver may be transmitted from the server 20 to the information terminal 11, and the information terminal 11 may obtain the consent of a user regarding the receiver.

As described above, according to the first example embodiment, the storage unit 21 associates face information of a user with user information including information about the sender and the receiver of the package P and stores them in advance. When the package P is accepted, the camera 11A captures an image of the face of a user, the face authentication unit 22 authenticates the captured face of the user, the user information acquisition unit 23 acquires user information associated with the authenticated face information of the user from the storage unit 21, the invoice number assignment unit 26 assigns an invoice number to the delivery of the package P, and the printer 14 issues an invoice including the information about the sender and the receiver included in the acquired user information and the invoice number.

Therefore, an invoice is issued by simply having a camera capture an image of the face of a user for face authentication. Thus, the user does not have to write user's information in the invoice by hand. As a result, the burden of preparing an invoice on the user is reduced.

Further, when a user writes user's information in the invoice by hand, a delivery driver who picks up the package may have trouble reading the handwritten invoice, or may not be able to read the invoice itself. According to the first example embodiment, an invoice is issued by the printer 14, and thus the burden of reading the invoice on a delivery driver is reduced.

Further, according to the first example embodiment, user information further includes payment information related to payment made by a user. Further, the measuring unit 12 measures the dimensions of the package P, the weight scale 13 measures the weight of the package P, the delivery charge calculation unit 24 calculates a delivery charge for the package P based on the current location, the information about the receiver included in user information, the dimensions and the weight of the package P, whether or not a delivery option is added to the package P, and the type of the delivery option when the delivery option is added, and the payment unit 25 performs payment of the delivery charge for the package P based on payment information included in the user information.

Therefore, the payment of the delivery charge is made by simply having a camera capture an image of the face of a user for face authentication. Thus, the user does not have to pay the delivery charge at a cash register. As a result, the burden of paying the delivery charge on a user is reduced. Further, the clerk of the store 10 does not have to measure the dimensions and the weight of the package P or calculate a delivery charge. As a result, the burden of measuring the package P or calculating a delivery charge on the store clerk is reduced.

Further, processes before an invoice is issued and the delivery charge is paid are automatically performed without performing any artificial processes by simply having a camera capture an image of the face of the user for face authentication. Therefore, human error is reduced.

### Second Example Embodiment

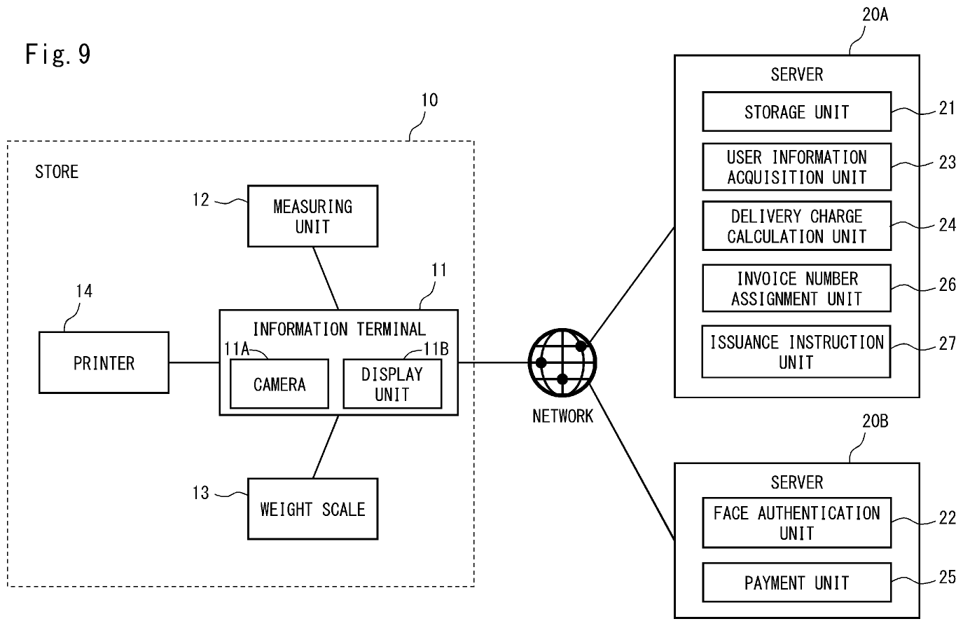

An example of a configuration of a package acceptance system according to a second example embodiment will be described with reference to FIG. 9.

As shown in FIG. 9, in the package acceptance system according to the second example embodiment, the components included in the server 20 according to the above-described first example embodiment are disposed in two servers 20A and 20B in a distributed manner.

Specifically, of the components included in the server 20, the server 20A includes the storage unit 21, the user information acquisition unit 23, the delivery charge calculation unit 24, the invoice number assignment unit 26, and the issuance instruction unit 27. Further, of the components included in the server 20, the server 20B includes the face authentication unit 22 and the payment unit 25.

In the second example embodiment, for example, a member number of a user may be added as user information to be stored in the storage unit 21, and information stored in the storage unit 21 and the like may be exchanged between the servers 20A and 20B using the member number as a key. Further, in FIG. 9, although the storage unit 21 is disposed in the server 20A, it may instead be disposed in the server 20B.

Note that the second example embodiment differs from the first example embodiment only in that the components included in the server 20 are disposed in a distributed manner, and these components according to the second example embodiment are similar to those according to the first example embodiment. Thus, operations performed in the second example embodiment are similar to those performed in the above-described first example embodiment and hence an effect similar to that in the above-described first example embodiment can be obtained. Therefore, the descriptions of the operations and the effect in the second example embodiment will be omitted.

### Third Example Embodiment

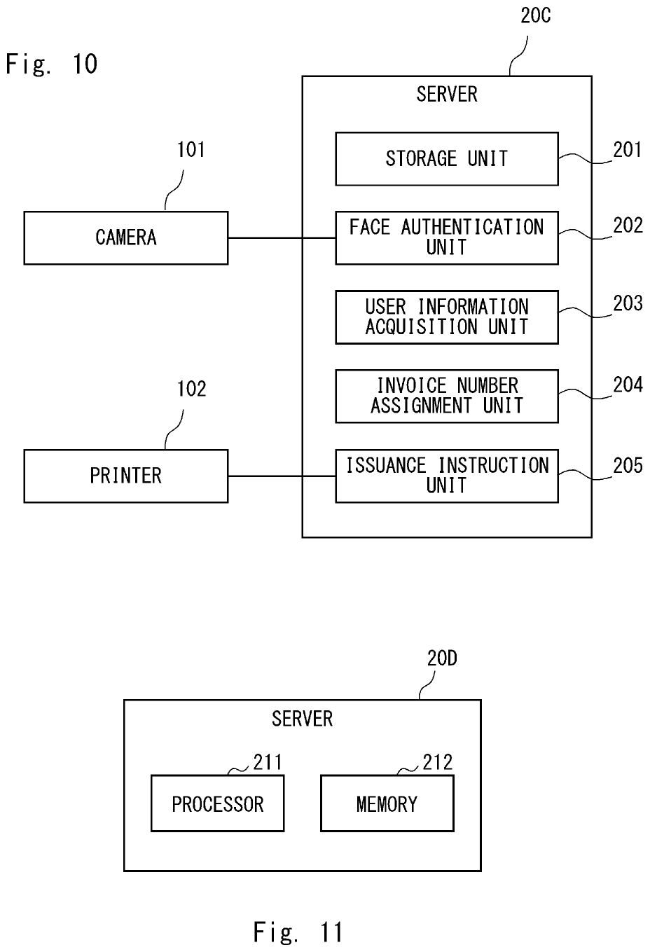

An example of a configuration of a package acceptance system according to a third example embodiment will be described with reference to FIG. 10. Note that the third example embodiment corresponds to an example embodiment in which the concept of the first example embodiment described above is broadened.

As shown in FIG. 10, the package acceptance system according to the third example embodiment includes a camera 101, a printer 102, and a server 20C. Further, the server 20C includes a storage unit 201, a face authentication unit 202, a user information acquisition unit 203, an invoice number assignment unit 204, and an issuance instruction unit 205.

The storage unit 201 associates face information of a user who requests delivery of the package P with user information including information about a sender and a receiver of the package P and stores them in advance. The storage unit 201 corresponds to the storage unit 21 according to the above-described first example embodiment.

The camera 101 captures an image of the face of a user when the package P is accepted. The camera 101 corresponds to the camera 11A according to the above-described first example embodiment.

The face authentication unit 202 authenticates the face of the user captured by the camera 101. The face authentication unit 202 corresponds to the face authentication unit 22 according to the above-described first example embodiment.

The user information acquisition unit 203 acquires user information associated with the face information of the user authenticated by the face authentication unit 202 from the storage unit 201. The user information acquisition unit 203 corresponds to the user information acquisition unit 23 according to the above-described first example embodiment.

The invoice number assignment unit 204 assigns an invoice number to the delivery of the package P. The invoice number assignment unit 204 corresponds to the invoice number assignment unit 26 according to the above-describe first example embodiment.

The issuance instruction unit 205 transmits an instruction for issuance of an invoice including the information about the sender and the receiver of the package P included in the user information acquired by the user information acquisition unit 203 and the invoice number assigned by the invoice number assignment unit 204 to the printer 102. The issuance instruction unit 205 corresponds to the issuance instruction unit 27 according to the above-described first example embodiment.

The printer 102 issues an invoice including the information about the sender and the receiver of the package P and the invoice number based on the instruction for issuance transmitted by the issuance instruction unit 205. The printer 102 corresponds to the printer 14 according to the above-described first example embodiment.

As described above, according to the third example embodiment, an invoice is issued by simply having a camera capture an image of the face of a user for face authentication. Thus, the user does not have to write user's information in the invoice by hand. As a result, the burden of preparing an invoice on the user is reduced.

Note that user information may further include payment information related to payment made by a user. Further, the package acceptance system according to the third example embodiment may further include a dimension measurement unit that measures the dimensions of the package P and a weight measurement unit that measures the weight of the package P. The dimension measurement unit and the weight measurement unit correspond to the measuring unit 12 and the weight scale 13 according to the above-described first example embodiment, respectively. Further, the server 20C may further include a delivery charge calculation unit that calculates a delivery charge for the package P based on the current location, the information about the receiver included in the user information acquired by the user information acquisition unit 203, the dimensions and the weight of the package P respectively measured by the dimension measurement unit and the weight measurement unit, whether or not a delivery option is added to the package P, and the type of the delivery option when the delivery option is added, and a payment unit that performs payment of the delivery charge calculated by the delivery charge calculation unit based on payment information included in the user information acquired by the user information acquisition unit 203. The delivery charge calculation unit and the payment unit correspond to the delivery charge calculation unit 24 and the payment unit 25 according to the above-described first example embodiment, respectively.

Further, the package acceptance system according to the third example embodiment may further include an operation reception unit that receives an operation performed by a user. The operation reception unit corresponds to the information terminal 11 according to the above-described first example embodiment. Further, a user may select, through the operation reception unit, whether or not to add a delivery option to the package P and the type of the delivery option when the delivery option is added.

Further, the package P is placed on the weight measurement unit, and the weight measurement unit may measure the weight of the package P placed thereon, and the dimension measurement unit may measure the dimensions of the package P in a state in which the package P is placed on the weight measurement unit.

Further, the camera 101 may further capture an image of the package P when the package P is accepted, and the storage unit 201 may associate the dimensions and the weight of the package P, whether or not a delivery option is added to the package P, the type of the delivery option when the delivery option is added, and the image of the package P captured by the camera 101 with face information of a user and user information, and store them.

Further, the printer 102 may issue an invoice using a two-dimensional code such as a QR code.

### Fourth Example Embodiment

An example of a hardware configuration of a server 20D according to a fourth example embodiment will be described with reference to FIG. 11.

As shown in FIG. 11, the server 20D according to the fourth example embodiment includes a processor 211 and a memory 212.

The processor 211 may be, for example, a microprocessor, a Micro Processing Unit (MPU), or a Central Processing Unit (CPU). The processor 211 may include a plurality of processors.

The memory 212 is composed of a combination of a volatile memory and a non-volatile memory. The memory 212 may include a storage located separately from the processor 211. In this case, the processor 211 may access the memory 212 via an Input/Output (I/O) interface (not shown).

Each of the servers 20 and 20A to 20C according to the above-described first to third example embodiments may have the hardware configuration shown in FIG. 11. A program is stored in the memory 212. This program includes instructions (or software codes) that, when loaded into a computer, cause the computer to perform one or more of the functions of the servers 20 and 20A to 20C described in the above-described first to third example embodiments. The face authentication units 22 and 202, the user information acquisition units 23 and 203, the delivery charge calculation unit 24, the payment unit 25, the invoice number assignment units 26 and 204, and the issuance instruction units 27 and 205 included in the above-described servers 20 and 20A to 20C may be implemented by having the processor 211 load a program stored in the memory 212 and execute it. Further, the storage units 21 and 201 included in the above-described servers 20 and 20A to 20C may be implemented by the memory 212.

Further, the above-described program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD), or other types of memory technologies, a CD-ROM, a digital versatile disc (DVD), a Blu-ray (Registered Trademark) disc, or other types of optical disc storage, and magnetic cassettes, magnetic tape, magnetic disk storage, or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Although the present disclosure has been described with reference to the example embodiments, the present disclosure is not limited to the above-described example embodiments. Various changes that may be understood by those skilled in the art may be made to the configurations and details of the present disclosure within the scope of the present disclosure.

For example, in the above-described example embodiments, although the invoice includes the information about the sender and the receiver of the package and the invoice number, the present disclosure is not limited thereto. As described above, the storage unit associates face information of a user with user information and stores them. For example, when the receiver (i.e., the destination) is a user's parents' home or the like, it can be considered that the receiver may want to confirm the face of the user. Therefore, the invoice may include information about the storage location where the face information of the user and the like are stored in the storage unit. The information about the storage location may be, for example, a Uniform Resource Locator (URL). By doing so, the receiver can access the corresponding storage location in the storage unit and confirm the face of the user.

Further, in the above-described example embodiments, the information terminal captures an image of the package using a camera when the package is accepted at the store. The information terminal may transmit the captured image of the package in advance to the terminal of a delivery driver who picks up the package. By doing so, the delivery driver can use the image of the package as loading information for loading the package into a truck.

Further, the whole or part of the example embodiments disclosed above can be described as, but not limited to, the following supplementary notes.

### Supplementary Note 1

A package acceptance system comprising:
a storage unit configured to associate face information of a user who requests delivery of a package with user information including information about a sender and a receiver of the package and store the associated information in advance;
a camera configured to capture an image of the face of the user when the package is accepted;
a face authentication unit configured to authenticate the captured face of the user;
a user information acquisition unit configured to acquire the user information associated with the authenticated face information of the user from the storage unit;
an invoice number assignment unit configured to assign an invoice number to the delivery of the package;
an issuance instruction unit configured to transmit an instruction for issuance of an invoice including the information about the sender and the receiver included in the acquired user information and the assigned invoice number; and
a printer configured to issue the invoice based on the instruction for issuance.

### Supplementary Note 2

The package acceptance system according to supplementary note 1, wherein
the user information further includes payment information related to payment made by the user, and
the package acceptance system further comprises:
   a dimension measurement unit configured to measure dimensions of the package;
   a weight measurement unit configured to measure a weight of the package;
   a delivery charge calculation unit configured to calculate a delivery charge for the package based on a current location, the information about the receiver included in the acquired user information, the measured dimensions and weight of the package, whether or not a delivery option is added to the package, and a type of the delivery option when the delivery option is added; and
   a payment unit configured to perform payment of the calculated delivery charge based on the payment information included in the acquired user information.

### Supplementary Note 3

The package acceptance system according to supplementary note 2, further comprising an operation reception unit configured to receive an operation performed by the user, wherein
the user selects, through the operation reception unit, whether or not to add the delivery option to the package and the type of the delivery option when the delivery option is added.

### Supplementary Note 4

The package acceptance system according to supplementary note 2 or 3, wherein
the package is placed on the weight measurement unit, and the weight measurement unit measures the weight of the package placed on the weight measurement unit, and
the dimension measurement unit measures the dimensions of the package in a state in which the package is placed on the weight measurement unit.

### Supplementary Note 5

The package acceptance system according to any one of supplementary notes 2 to 4, wherein
the camera further captures an image of the package when the package is accepted, and
the storage unit associates the dimensions and the weight of the package, whether or not the delivery option is added to the package, the type of the delivery option when the delivery option is added, and the captured image of the package with the face information of the user and the user information, and stores them.

### Supplementary Note 6

The package acceptance system according to any one of supplementary notes 1 to 5, wherein the printer issues the invoice using a two-dimensional code.

Supplementary Note 7

A server comprising:
a storage unit configured to associate face information of a user who requests delivery of a package with user information including information about a sender and a receiver of the package and store the associated information in advance;
a face authentication unit configured to authenticate the face of the user captured by a camera when the package is accepted;
a user information acquisition unit configured to acquire the user information associated with the authenticated face information of the user from the storage unit;
an invoice number assignment unit configured to assign an invoice number to the delivery of the package; and
an issuance instruction unit configured to transmit, to a printer, an instruction for issuance of an invoice including the information about the sender and the receiver included in the acquired user information and the assigned invoice number.

### Supplementary Note 8

The server according to supplementary note 7, wherein
the user information further includes payment information related to payment made by the user, and
the server further comprises:
   a delivery charge calculation unit configured to calculate a delivery charge for the package based on a current location, the information about the receiver included in the acquired user information, dimensions and a weight of the package respectively measured by the dimension measurement unit and the weight measurement unit, whether or not a delivery option is added to the package, and a type of the delivery option when the delivery option is added; and
   a payment unit configured to perform payment of the calculated delivery charge based on the payment information included in the acquired user information.

### Supplementary Note 9

The server according to supplementary note 8, wherein the storage unit associates the dimensions and the weight of the package, whether or not the delivery option is added to the package, the type of the delivery option when the delivery option is added, and the image of the package captured by the camera when the package is accepted with the face information of the user and the user information, and stores them.

### Supplementary Note 10

A package acceptance method performed by a server, the package acceptance method comprising:
associating face information of a user who requests delivery of a package with user information including information about a sender and a receiver of the package and storing the associated information in a storage unit in advance;
authenticating the face of the user captured by a camera when the package is accepted;
acquiring the user information associated with the authenticated face information of the user from the storage unit;
assigning an invoice number to the delivery of the package; and
transmitting, to a printer, an instruction for issuance of an invoice including the information about the sender and the receiver included in the acquired user information and the assigned invoice number.

### Supplementary Note 11

A non-transitory computer readable medium storing a program for causing a computer to execute:
a procedure of associating face information of a user who requests delivery of a package with user information including information about a sender and a receiver of the package and storing the associated information in a storage unit in advance;
a procedure of authenticating the face of the user captured by a camera when the package is accepted;
a procedure of acquiring the user information associated with the authenticated face information of the user from the storage unit;
a procedure of assigning an invoice number to the delivery of the package; and
a procedure of transmitting, to a printer, an instruction for issuance of an invoice including the information about the sender and the receiver included in the acquired user information and the assigned invoice number.

### REFERENCE SIGNS LIST

10 STORE
11 INFORMATION TERMINAL
11A, 101 CAMERA
11B DISPLAY UNIT
12 MEASURING UNIT
12A DEPTH SENSOR
13 WEIGHT SCALE
13A WEIGHT SCALE BODY PART
13B WEIGHT DISPLAY UNIT
14, 102 PRINTER
15 MOUNTING TABLE
16 SENSOR ATTACHMENT PART
16A SUPPORT PILLAR
16B SENSOR ATTACHMENT MEMBER
20, 20A to 20D SERVER
21, 201 STORAGE UNIT
22, 202 FACE AUTHENTICATION UNIT
23, 203 USER INFORMATION ACQUISITION UNIT
24 DELIVERY CHARGE CALCULATION UNIT
25 PAYMENT UNIT
26, 204 INVOICE NUMBER ASSIGNMENT UNIT
27, 205 ISSUANCE INSTRUCTION UNIT
211 PROCESSOR
212 MEMORY

What is claimed is:

1. A package acceptance system comprising:
a storage unit configured to associate face information of a user who requests delivery of a package with user information including information about a sender and a receiver of the package, store the associated information in advance and store instructions;
a camera configured to capture an image of the face of the user when the package is accepted;
at least one processor configured to execute the instructions to;
authenticate the captured face of the user;
acquire the user information associated with the authenticated face information of the user from the storage unit;
assign an invoice number to the delivery of the package;
transmit an instruction for issuance of an invoice including the information about the sender and the receiver included in the acquired user information and the assigned invoice number; and
a printer configured to issue the invoice based on the instruction for issuance.

2. The package acceptance system according to claim 1, wherein
the user information further includes payment information related to payment made by the user, and
the package acceptance system further comprises:
a dimension measurement unit configured to measure dimensions of the package; and
a weight measurement unit configured to measure a weight of the package;
wherein the at least one processor is further configured to execute the instructions to;
calculate a delivery charge for the package based on a current location, the information about the receiver included in the acquired user information, the measured dimensions and weight of the package, whether or not a delivery option is added to the package, and a type of the delivery option when the delivery option is added; and
perform payment of the calculated delivery charge based on the payment information included in the acquired user information.

3. The package acceptance system according to claim 2, further comprising an operation reception unit configured to receive an operation performed by the user, wherein
the user selects, through the operation reception unit, whether or not to add the delivery option to the package and the type of the delivery option when the delivery option is added.

4. The package acceptance system according to claim 2, wherein
the package is placed on the weight measurement unit, and the weight measurement unit measures the weight of the package placed on the weight measurement unit, and
the dimension measurement unit measures the dimensions of the package in a state in which the package is placed on the weight measurement unit.

5. The package acceptance system according to claim 2, wherein
the camera further captures an image of the package when the package is accepted, and
the storage unit associates the dimensions and the weight of the package, whether or not the delivery option is added to the package, the type of the delivery option when the delivery option is added, and the captured image of the package with the face information of the user and the user information, and stores them.

6. The package acceptance system according to claim 1, wherein the printer issues the invoice using a two-dimensional code.

7. A server comprising:
a storage unit configured to associate face information of a user who requests delivery of a package with user information including information about a sender and a receiver of the package, store the associated information in advance and store instructions;
at least one processor configured to execute the instructions to;
authenticate the face of the user captured by a camera when the package is accepted;
acquire the user information associated with the authenticated face information of the user from the storage unit;
assign an invoice number to the delivery of the package; and
transmit, to a printer, an instruction for issuance of an invoice including the information about the sender and the receiver included in the acquired user information and the assigned invoice number.

8. The server according to claim 7, wherein
the user information further includes payment information related to payment made by the user, and
the at least one processor is further configured to execute the instructions to;
calculate a delivery charge for the package based on a current location, the information about the receiver included in the acquired user information, dimensions and a weight of the package respectively measured by the dimension measurement unit and the weight measurement unit, whether or not a delivery option is added to the package, and a type of the delivery option when the delivery option is added; and
perform payment of the calculated delivery charge based on the payment information included in the acquired user information.

9. The server according to claim 8, wherein the storage unit associates the dimensions and the weight of the package, whether or not the delivery option is added to the package, the type of the delivery option when the delivery option is added, and the image of the package captured by the camera when the package is accepted with the face information of the user and the user information, and stores them.

10. A package acceptance method performed by a server, the package acceptance method comprising:
associating face information of a user who requests delivery of a package with user information including information about a sender and a receiver of the package and storing the associated information in a storage unit in advance;
authenticating the face of the user captured by a camera when the package is accepted;
acquiring the user information associated with the authenticated face information of the user from the storage unit;
assigning an invoice number to the delivery of the package; and
transmitting, to a printer, an instruction for issuance of an invoice including the information about the sender and the receiver included in the acquired user information and the assigned invoice number.

11. (canceled)
